(19) United States
(12) Patent Application Publication
(10) Pub. No.: US 2014/0191838 A1
(43) Pub. Date: Jul. 10, 2014

(54) COMMON MODE NOISE FILTER AND PRODUCTION METHOD THEREFOR

(71) Applicant: Noritaka Yoshida, Osaka (JP)

(72) Inventor: Noritaka Yoshida, Osaka (JP)

(73) Assignee: PANASONIC CORPORATION, Osaka (JP)

(21) Appl. No.: 14/238,181

(22) PCT Filed: Sep. 13, 2012
(86) PCT No.: PCT/JP2012/005829

§ 371 Date: Feb. 10, 2014

(30) Foreign Application Priority Data
Sep. 15, 2011 (JP) 2011-201437
Sep. 15, 2011 (JP) 2011-201438

(51) Int. Cl. H01F 27/28

(52) U.S. Cl. CPC H01F 27/2804
USPC 336/200

(57) ABSTRACT

A common mode noise filter includes a first insulating layer, a first coil conductor on an upper surface of the first insulating layer, a second coil conductor on a lower surface of the first insulating layer, a second insulating layer on the upper surface of the first insulating layer to cover the first coil conductor, a third insulating layer on a lower surface of the second insulating layer to cover the second coil conductor. The first insulating layer contains glass and inorganic filler, and contains pores dispersed therein. The second insulating layer covers the first coil conductor, contains glass and inorganic filler, and contains pores dispersed therein. The third insulating layer covers the second coil conductor, contains glass and inorganic filler, and contains pores dispersed therein. This common mode noise filter has excellent high-frequency characteristics at a high yield rate.

### TECHNICAL FIELD

The present invention relates to a common mode noise filter having a pair of coil conductors sandwiched by magnetic substrates, and it also relates to a method for manufacturing the same filter.

### BACKGROUND ART

In recent years, a high-speed interface, such as a universal serial bus (USB) and an high-definition multimedia interface (HDMI), has been upgraded to work with a higher speed. This market trend invites a problem of how to deal with radiated noise. A common mode noise may cause the unintended noises, so that the market may demand a common mode noise filter working at the higher frequency in order to remove common mode noises.

The common mode noise filter includes two coils wound in the same direction. An electric current flowing through a coil generates a magnetic field, so that a self-inductance produces a braking effect.

The two coils of the common mode noise filter utilize an interaction between the coils for preventing an electric current of a common mode noise from passing through. To be more specific, when currents in differential mode flow through the two coils, the currents flow in directions opposite to each other, so that magnetic fluxes generated by the currents cancel each other smooth the currents. However, the currents of the common mode noise flows in the same direction cause the magnetic fluxes generated in the coils to be combined together and strengthened by each other. As a result, a greater braking effect is produced due to electromotive force of the self-inductance, and prevents the current of the common mode noise from passing through.

Patent Literature 1 discloses a common mode noise filter including plural conductive coil patterns and insulating layers stacked between a pair of layers made of magnetic oxide. The pair of layers is made of Ni—Zn—Cu based ferrite, and the insulating layers are made of Cu—Zn based ferrite or Zn based ferrite.

This common mode noise filter is expected to exercise its function more effectively by getting the two coils closer to each other, thereby combining and strengthening magnetic fluxes generated. The stronger braking effect can be thus obtained. However, a closer placement of the two coils to each other will generate a large amount of a stray capacitance between the coils to produce a resonance, and prevents an electric current of a high-frequency signal from passing through.

Since electronic devices work at a higher frequency in recent years, glass-based materials are widely used for an insulating layer. In general, a dielectric constant of glass-based material which contains silica-based filler of a low dielectric constant and is used as an additive ranges from 4 to 6 while a dielectric constant of ferrite material ranges from 10 to 15. The noise filter disclosed in Patent Literature 2 includes insulating layers made of glass-based material to reduce a stray capacitance between the coils. As a result, this noise filter has better performance than a noise filter that employs insulating layers made of conventional non-magnetic ferrite material.

Patent Literature 3 discloses a ceramic electronic component and a method for manufacturing the same component. This ceramic electronic component employs a material having pores therein and a low dielectric constant. Insulating layers are laminated between a pair of coil conductors confronting each other, thereby forming a laminated body. Each of the insulating layers is made of glass-based material and has multiple pores therein. This laminated body reduces appreciably the stray capacitance between the coils. As a result, a common mode noise filter phenomenally excellent in high-frequency characteristics can be obtained.

However, in the case that the magnetic oxide layers are made of Ni—Zn—Cu based ferrite, each of the elements (i.e. magnetic oxide layers, insulating layers, and coil conductors) is made of materials different from each other. The laminated body can hardly be formed unitarily by firing these elements simultaneously free from structural failures, such as cracks or delamination between the layers. On top of that, even if an appropriate firing condition is found to the simultaneous firing of respective layers of the laminated body, and the laminated body could be formed unitarily, there is still a problem: During a heat-treat step (e.g. baking an external terminal electrode printed on the laminated body) after the firing step, cracks can be sometimes produced in the insulating layers between the coil conductors.

### CITATION LIST

### Patent Literature

Patent Literature 1: Japanese Patent Laid-Open Publication No. 2003-124028

Patent Literature 2: Japanese Patent Laid-Open Publication No. 2004-235494

Patent Literature 3: Japanese Patent Laid-Open Publication No. 11-067575

### SUMMARY

A common mode noise filter includes a first insulating layer, a first coil conductor on an upper surface of the first insulating layer, a second coil conductor on a lower surface of the first insulating layer, a second insulating layer on the upper surface of the first insulating layer to cover the first coil conductor, a third insulating layer on a lower surface of the second insulating layer to cover the second coil conductor. The first insulating layer contains glass and inorganic filler, and contains pores dispersed therein. The second insulating layer covers the first coil conductor, contains glass and inorganic filler, and contains pores dispersed therein. The third insulating layer covers the second coil conductor, contains glass and inorganic filler, and contains pores dispersed therein.

This common mode noise filter has excellent high-frequency characteristics at a high yield.

### BRIEF DESCRIPTION OF DRAWINGS

FIG. 1 is a perspective view of a common mode noise filter in accordance with Exemplary Embodiment 1 of the present invention.

FIG. 2 is an exploded perspective view of the common mode noise filter in accordance with Embodiment 1.

FIG. 3 is a cross-sectional view of the common mode noise filter at line 3-3 shown in FIG. 1.

FIG. 4 is an enlarged cross-sectional view of the common mode noise filter shown in FIG. 1.

FIG. 5 is an enlarged cross-sectional view of another common mode noise filter in accordance with Embodiment 1.

FIG. 6 is a schematic view of the common mode noise filter in accordance with Embodiment 1 for illustrating processes for manufacturing the filter.

FIG. 7 shows a test result of the common mode noise filter in accordance with Embodiment 1.

FIG. 8 is a perspective view of a common mode noise filter in accordance with Exemplary Embodiment 2 of the invention.

FIG. 9 is an exploded perspective view of the common mode noise filter in accordance with Embodiment 2.

FIG. 10 is a cross-sectional view of the common mode noise filter at line 10-10 shown in FIG. 8.

FIG. 11 is an enlarged cross-sectional view of the common mode noise filter shown in FIG. 8.

FIG. 12 shows a test result of the common mode noise filter in accordance with Embodiment 2.

FIG. 13 is a schematic view of the common mode noise filter in accordance with Embodiment 2 for illustrating processes for manufacturing the filter.

### DETAIL DESCRIPTION OF PREFERRED EMBODIMENTS

### Exemplary Embodiment 1

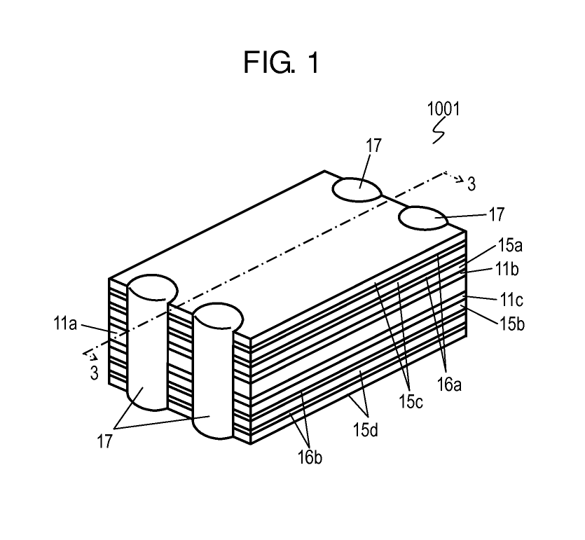

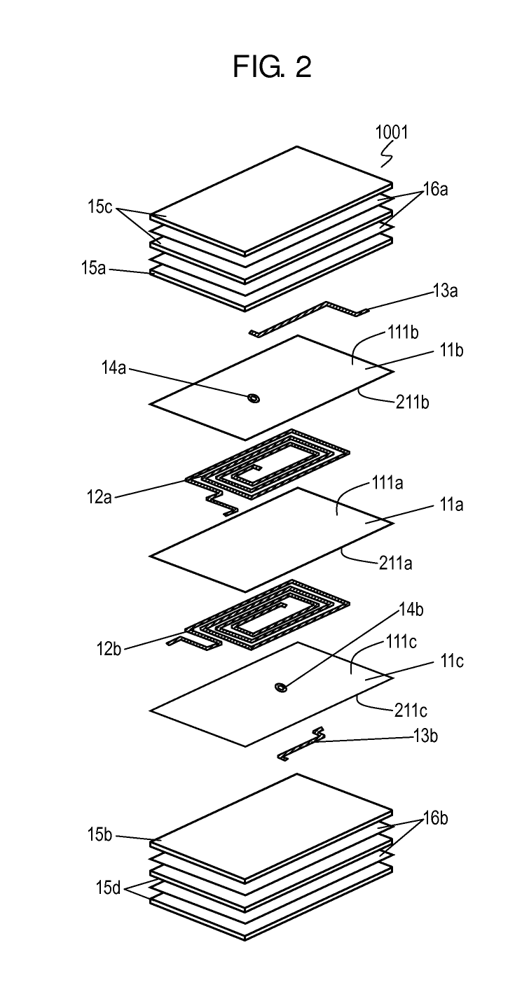

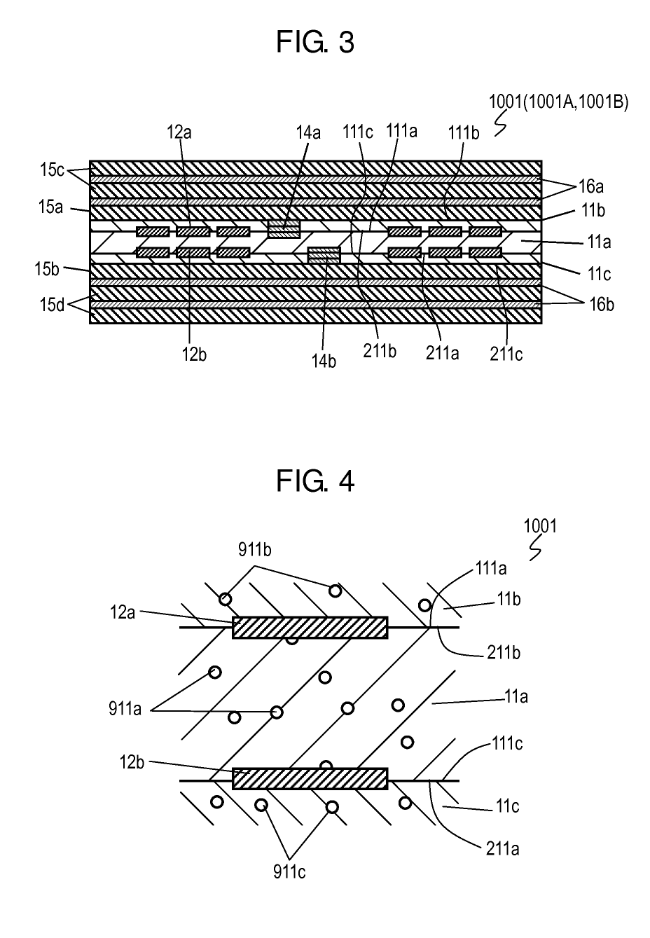

FIGS. 1 and 2 are a perspective view and an exploded perspective view of common mode noise filter 1001 in accordance with Exemplary Embodiment 1 of the present invention. FIG. 3 is a cross-sectional view of common mode noise filter 1001 at line 3-3 shown in FIG. 1.

Common mode noise filter 1001 includes insulating layer 11a, coil conductor 12a disposed on upper surface 111a of insulating layer 11a, insulating layer 11b disposed on upper surface 111a of insulating layer 11a to contact coil conductor 12a to cover coil conductor 12a, coil conductor 12b disposed on lower surface 211a of insulating layer 11a, insulating layer 11c disposed on lower surface 211a of insulating layer 11a to contact coil conductor 12b to cover coil conductor 12b, magnetic oxide layer 15a disposed on upper surface 111b of insulating layer 11b, magnetic oxide layer 15b disposed on lower surface 211c of insulating layer 11c, leading electrode 13a electrically connected to coil conductor 12a, via-electrode 14a for connecting coil conductor 12a to leading electrode 13a, leading electrode 13b electrically connected to coil conductor 12b, via-electrode 14b for connecting coil conductor 12b to leading electrode 13b, and external terminal electrodes 17. External terminal electrodes 17 are connected to coil conductors 12a and 12b and leading electrodes 13a and 13b. Common mode noise filter 1001 may further include one or more magnetic oxide layers 15c made of the same material as magnetic oxide layer 15a, one or more magnetic oxide layers 15d made of the same material as magnetic oxide layer 15b, one or more insulating layers 16a, and one or more insulating layers 16b. Insulating layers 16a are stacked alternately on magnetic oxide layer 15a and magnetic oxide layers 15c. Insulating layer 16b is layered such that it is sandwiched by magnetic oxide layer 15b and magnetic oxide layer 15d. Leading electrode 13a is disposed on upper surface 111b of insulating layer 11b. Via-electrode 14a penetrates insulating layer 11b from upper surface 111b to lower surface 211b. Magnetic oxide layer 15a is disposed on upper surface 111b of insulating layer 11b to contact and cover leading electrode 13a. Leading electrode 13b is disposed on lower surface 211c of insulating layer 11c. Via-electrode 14b penetrates insulating layer 11c from upper surface 111c to lower surface 211c. Magnetic oxide layer 15b is disposed on lower surface 211c of insulating layer 11c to contact and cover leading electrode 13b.

Insulating layer 11a contains borosilicate glass and inorganic filler. Insulating layers 11a, 11b, and 11c are provided between magnetic oxide layers 15a and 15b. Insulating layers 16a and 16b contain glass component but contain no pores dispersed therein. Insulating layers 11a, 11b, and 11c is different from magnetic oxide layers 15a, 15b, 15c, and 15d in that Insulating layers 11a, 11b, and 11c are non-magnetic layers having substantially no magnetic property.

Magnetic oxide layers 15a, 15b, 15c, and 15d are made of magnetic material, such as ferrite mainly made of Fe₂O₃. According to Embodiment 1, the total number of magnetic oxide layers 15a and 15c is three, and that of insulating layers 16a is two. The total number of magnetic oxide layers 15b and 15d is three, and that of insulating layers 16b is two. Insulating layers 16a and magnetic oxide layers 15c and 15a are arranged alternately. Insulating layers 16b and magnetic oxide layers 15b and 15d are arranged alternately. This structure increases adhesive strength between external terminal electrodes 17 and filter 1001. Contraction behavior due to the firing of magnetic oxide layers 15a, 15b, 15c, and 15d which are made of material different from that of insulating layer 11a becomes more similar to that of insulating layer 11a, accordingly preventing cracks or delamination between the layers. The total number of layers 15a and 15c can be two, and the total number of layers 15b and 15d can be also two. Common mode noise filter 1001 does not necessarily include insulating layers 16a and 16b containing glass component.

Coil conductors 12a and 12b can be formed by shaping a conductive material, such as Ag, into a spiral shape, and plating the spiral shape. Coil conductors 12a and 12b are electrically connected to leading electrodes 13a and 13b through via-electrodes 14a and 14b, respectively.

The shape of coil conductors 12a and 12b is not necessarily the spiral shape, and can be helical, meander or other shapes. Coil conductors 12a and 12b are not necessarily plated, but can be formed by printing, depositing or other methods.

FIG. 4 is an enlarged cross-sectional view of common mode noise filter 1001. Pores 911a are dispersed in insulating layer 11a. Pores 911b are dispersed in insulating layer 11b. Pores 911c are dispersed in insulating layer 11c. This structure reduces an effective dielectric constant of insulating layer 11a, and relieving stress concentrating on insulating layer 11a during heat-treating after the firing, thereby preventing cracks around coil conductors 12a and 12b.

A pore ratio which is a ratio of a total volume of pores 911a to the volume of insulating layer 11a preferably ranges from 5 to 40 vol. %. A pore ratio which is a ratio of a total volume of pores 911b to the volume of insulating layer 11b preferably ranges from 5 to 40 vol. %. A pore ratio which is a ratio of a total volume of pores 911c to the volume of insulating layer 11c preferably ranges from 5 to 40 vol. %. This structure reduces the dielectric constant of insulating layer 11a appropriately while maintaining the material strength thereof.

Inorganic foaming agent which is thermally discomposed and to generate gas in a temperature range including the firing temperature and its vicinity is preferably mixed with glass powder and inorganic filler powder which are powder of material of insulating layers 11a to 11c to form pores 911a to 911c in insulating layers 11a to 11c.

In order to form pores in glass or ceramics, disappearing particles or hollow particles which disappear during the firing can be added to the material powder. The disappearing particles can be particles of resin, such as polyethylene.

However, the method of making pores employing the resin particles as disappearing particles causes the resin particles to disappear up to about 500° C. The resin particles tends to form pores open to surfaces of insulating layers 11a to 11c and communicating with each other in order to obtain the pore ratios within the above range. These pores may readily absorb moisture and degrade reliability. If the materials are sintered to prevent the open and communicating pores from being generated, the pore ratio may decrease.

The method of forming the pores employing the hollow particles does not produce the open pores theoretically, so that a material of the electrode does not enter into the pores or bite the pores. This structure prevents the adhesive strength between coil conductors 12a and 12b and the insulating layers from increasing. Further, the hollow particles are generally expensive, so that this method increases the manufacturing cost.

In the above method employing the inorganic foaming agent as an additive, the contraction of insulating layers 11a to 11c due to the firing progresses to a certain degree in the firing temperature range, and melt liquid of the glass wets the filler and the inorganic foaming agent. Then, the foaming agent is thermally decomposed and generates gas. This mechanism allows the gas to be appropriately trapped in the glass, hence producing independent closed pores densely. This method thus can provide a high pore ratio easily, and form independent closed pores, hence securing the adhesive strength between coil conductors 12a and 12b and insulating layers 11a to 11c easily.

The open pore is a pore having a portion communicating with an outside of the glass-based material of the insulating layer. The closed pore is a pore that is formed inside the glass-based material and does not communicate with the outside of the glass-based material. The inorganic foaming agent preferably employs CaCO₃ or SrCO₃.

As discussed above, CaCO₃ or SrCO₃ is preferable as the inorganic foaming agent; however, CaCO₃ and SrCO₃ can be mixed together. As long as being discomposed at a temperature ranging from 600° C. to 1000° C., carbonate, nitrate, or sulfate can be used as the inorganic foaming agent. For instance, BaCO₃, Al₂(SO₄)₃, Ce₂(SO₄)₃ can be used as the inorganic foaming agent. A decomposition completion temperature at which the inorganic foaming agent is completed to decompose ranges from 600° C. to 1000° C., more preferably from 700° C. to 1000° C. The decomposition completion temperature within this range allows the gas generated during the temperature rise to be appropriately trapped inside insulating layers 11a, 11b, and 11c.

The decomposition completed temperature discussed above is a temperature at which weight reduction is completed in a TG chart. The TG chart is drawn by measuring the material powder of the foaming agent by a TG-DTA method (with TG8120 by RIGAKU Co. Ltd).

The amount of the inorganic foaming agent added preferably ranges from 1 wt % to 4 wt %. The amount of the inorganic foaming agent not larger than 5 wt % can hardly produce open and communicating pores which are formed of pores communicating with each other, hence allowing a water absorption rate of insulating layers 11a, 11b, and 11c to be not larger than 0.5%. This structure provides sufficient insulation reliability without providing any special treatment, such as resin impregnation.

The glass composition of the borosilicate glass of insulating layers 11a to 11c preferably contains Al₂O₃ in addition to SiO₂ and B₂O₃, and at least one material selected from oxide alkali metals. The glass composition desirably contains substantially no PbO in order not to avoid adverse effects on the environment.

The borosilicate glass of insulating layers 11a to 11c preferably has a yield point not lower than 550° C. and not higher than 750° C. If the yield point is lower than 550° C., the glass may deform significantly during the firing, and may have resistance to chemical reduced to provide a problem during plating. If the yield point exceeds 750° C., sufficient densification cannot be obtained in the temperature range in which coil conductors 12a and 12b and insulating layers 11a to 11c can be fired simultaneously.

The yield point of glass according to the embodiment is a temperature at which a glass state is transformed from expansion to contraction for a sample of glass having a bar shape and the temperature is measured by a TMA method with TMA8310 (made by RIGAKU Co., Ltd).

The inorganic filler in insulating layers 11a to 11c can be material, such as aluminum oxide, diopside, mulite, cordierite, or silica, resisting reacting with borosilicate glass during the firing. Cordierite or silica having a low dielectric constant is preferable for the inorganic filler since they can effectively reduce the dielectric constant of insulating layer 11a disposed between coil conductors 12a and 12b, the dielectric constant of insulating layer 11b disposed between coil conductor 12a and leading electrode 13a, and the dielectric constant of insulating layer 11c disposed between coil conductor 12b and leading electrode 13b.

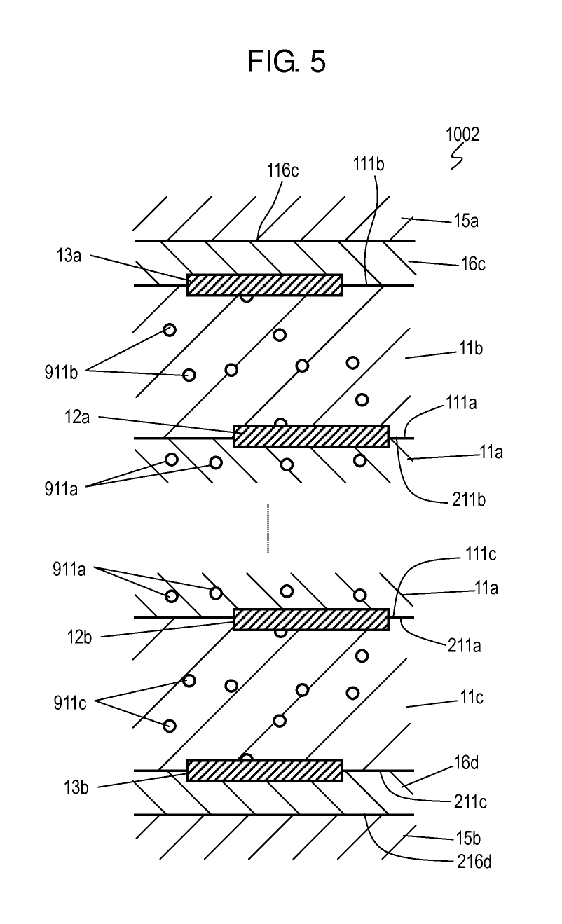

FIG. 5 is an enlarged cross-sectional view of another common mode noise filter 1002 in accordance with Embodiment 1. In FIG. 5, components identical to those of common mode noise filter 1001 shown in FIGS. 3 and 4 are denoted by the same reference numerals. In filter 1002, insulating layer 16c containing glass component is disposed on upper surface 111b of insulating layer 11b to contact and cover leading electrode 13a. Magnetic oxide layer 15a is disposed on upper surface 116c of insulating layer 16c. Insulating layer 16d containing glass component is disposed on lower surface 211c of insulating layer 11c to contact and cover leading electrode 13b. Magnetic oxide layer 15b is disposed on lower surface 216d of insulating layer 16d. Magnetic oxide layers 15a and 15b thus do not contact leading electrodes 13a and 13b, respectively. Since magnetic oxide layers 15a and 15b can be hardly sintered in the temperature range in which magnetic oxide layers 15a and 15b can be fired simultaneously to Ag, magnetic oxide layers 15a and 15b located away from leading electrodes 13a and 13b increases the reliability of moisture absorption. Insulating layers 16c and 16d have no pores dispersed therein.

The above components of common mode noise filter 1001 (1002) are merged together for forming laminated body 1001A. Four external terminal electrodes 17 made of Ag are provided on both sides of laminated body 1001A. External terminal electrodes 17 are connected to coil conductors 12a and 12b and leading electrodes 13a and 13b. A nickel-plated layer or a tin-plated layer may be preferably provided on surfaces of external terminal electrodes 17 to prevent electrodes 17 from corrosion.

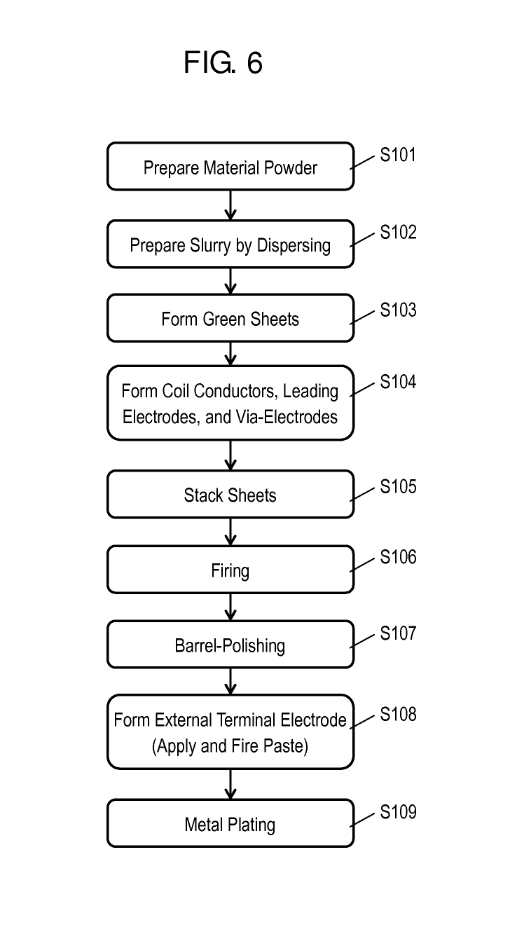

A method for manufacturing common mode noise filter 1001 will be described below. FIG. 6 shows processes for manufacturing common mode noise filter 1001.

First, an insulating sheet constituting insulating layer 11a is provided: 63 wt & of borosilicate glass powder, 4 wt % of SrCO₃ powder, and 33 wt % of inorganic filler are mixed together to prepare mixed powder (Step S101). Then, butyral resin (PVB), acrylic resin, and butyl benzyl phthalate (BBP) plasticizer are mixed together to produce an organic binder. The above mixed powder is dispersed in this organic binder to prepare a slurry (Step S102).

Next, this slurry is applied onto a polyethylene terephthalate (PET) film by a doctor blade method to shape the slurry, thereby forming an insulating sheet, i.e., a green sheet (Step S103).

Insulating sheets constituting insulating layers 11b and 11c are provided. 63 wt % of borosilicate glass powder, 4 wt % of SrCO₃ powder, and 33 wt % of inorganic filler are mixed together to produce mixed powder. Then, a slurry is produced from this mixed powder, and shaped into the insulating sheets by the same production method for making the insulating sheet constituting insulating layer 11a.

Magnetic oxide sheets constituting magnetic oxide layers 15a to 15d are provided. 100 wt % of ferrite material powder is prepared. Then, a slurry is produced form this powder and shaped into magnetic oxide sheets by the same production method for the insulating sheet constituting insulating layer 11a.

Insulating sheets constituting insulating layers 16a and 16b are prepared. 69 wt % of borosilicate glass powder and 31 wt % of inorganic filler are mixed together to produce mixed powder. Then, a slurry is produced from this mixed powder and shaped into the insulating sheets by the same production method for the insulating sheet constituting insulating layer 11a.

According to Embodiment 1, as discussed above, insulating layer 11a is made of the same materials as insulating layers 11b and 11c, but may be made of different materials with the same effects as long as insulating layers 11a, 11b, and 11c have plural pores dispersed therein.

Next, via-holes are formed at predetermined positions in the insulating sheet constituting insulating layers 11b and 11c. Then, the via-holes are filled with conductive paste made of Ag powder and glass frit. This conductive paste is fired to form via-electrodes 14a and 14b (Step S104).

Then, coil conductors 12a and 12b and leading electrodes 13a and 13b are formed. Conductive patterns constituting coil conductors 12a and 12b and leading electrodes 13a and 13b are formed on a base board by plating with Ag. Then, the patterns are transferred from the base board to the insulating sheets constituting insulating layers 11a to 11c.

The method for producing these sheets is not limited to the above method, for instance, each layer can be formed by a paste printing method. The method for producing coil conductors 12a and 12b, leading electrodes 13a and 13b, and via-electrodes 14a and 14b are not limited to the above method.

Then, the sheets including the insulating sheet having the conductive patterns transferred thereto are stacked to form a laminated body. The laminated body is then cut into chips having predetermined sizes, thereby obtaining laminated bodies 1001A (Step S105). A chip component, such as common mode noise filter 1001, is produced by cutting the laminated body having a size of a square larger than of 50 mm by 50 mm into chips each having a size of a square of about 1-2 mm by 1-2 mm to obtain laminated body 1001A.

Next, laminated body 1001A is fired at a predetermined temperature for a predetermined period of time to sinter the laminated body and to generate gas from the inorganic foaming agent, thereby providing fired body 1001B (Step S106). At this moment, the inorganic foaming agent, i.e., SrCO₃ powder mixed in the materials of insulating layers 11a to 11c is thermally decomposed, and produces carbon dioxide gas in laminated body 1001A. The gas forms plural pores 911a to 911c in insulating layers 11a to 11c while Sr element is left in insulating layers 11a to 11c. In the case that CaCO₃ is used for the inorganic foaming agent, plural pores 911a to 911c are formed in insulating layers 11a to 11c, and Ca element is left in insulating layers 11a to 11c.

Then, the fired body is provided with barrel finishing (Step S107). To be more specific, about 10,000 pieces of the fired bodies are is put into a planetary mill together with media having diameters of 2 mm, SiC polishing agent, and pure water. The mill is then spun at 150 rpm for 10 minutes, thereby removing undulations on the surface of the fired bodies as well as rounding sharp portions thereon, thereby allowing external terminal electrodes 17 to be applied securely onto the fired body easily.

After the barrel finishing, the conductive paste made of Ag powder and glass frit are applied onto both sides of the fired body so that coil conductors 12a and 12b are connected with leading electrodes 13a and 13b. Then, the conductive paste is fired at a temperature of 700° C. to form external terminal electrodes 17 (Step S108).

Insulating layers 11a to 11c of common mode noise filter 1001 in accordance with Embodiment 1 contain only independent closed pores therein and few open communicating pores, hence having sufficient insulating reliability without a post treatment, such as resin impregnation. In order to obtain higher reliability, after external terminal electrodes 17 are formed, the fired body can be immersed into fluoro-silane coupling agent so that the open pores in the surface can be impregnated with resin.

The surface of each external terminal electrode 17 has a nickel-plated layer and a tin-plated layer by plating, thereby providing common mode noise filter 1001 (Step S109).

The advantage of preventing cracks from occurring in insulating layer 11a disposed between coil conductors 12a and 12b of common mode noise filter 1001 or 1002 in accordance with Embodiment 1 will be described below with reference to the accompanying drawings.

Glass in insulating layer 11a can employ, e.g. borosilicate glass having a thermal expansion coefficient ranging from 3 to 6 ppm/K. Coil conductors 12a and 12b can be made of Ag or Cu. The thermal expansion coefficients of Ag and Cu are about 19 ppm/K and 17 ppm/K, respectively, and are considerably different from the thermal expansion coefficient of borosilicate glass ranging from 3 to 6 ppm/K. Insulating layer 11a contains plural pores 911a dispersed therein, hence not having a large strength. In the case that a rigid layer made of, e.g. ferrite containing substantially no pores therein is provided on an upper surface of coil conductor 12a disposed on upper surface 111a of insulating layer 11a or a lower surface of coil conductor 12b disposed on lower surface 211a of insulating layer 11a, a thermal stress tends to concentrate on insulating layer 11a rather than on the rigid layer since insulating layer 11a has a smaller strength, hence producing cracks in insulating layer 11a.

In common mode noise filters 1001 and 1002 in accordance with Embodiment 1, insulating layer 11b containing plural pores 911b dispersed therein is disposed on the upper surface of coil conductor 12a, and insulating layer 11c containing plural pores 911c dispersed therein is disposed on the lower surface of coil conductor 12b. This structure allows the thermal stress to dispersedly distribute in insulating layers 11a and 11b adjacent to each other across coil conductor 12a. Similarly, the thermal stress dispersedly distribute in insulating layers 11a and 11c adjacent to each other across coil conductor 12b. This structure relieves the stress concentrating on insulating layer 11a, and prevents the cracks.

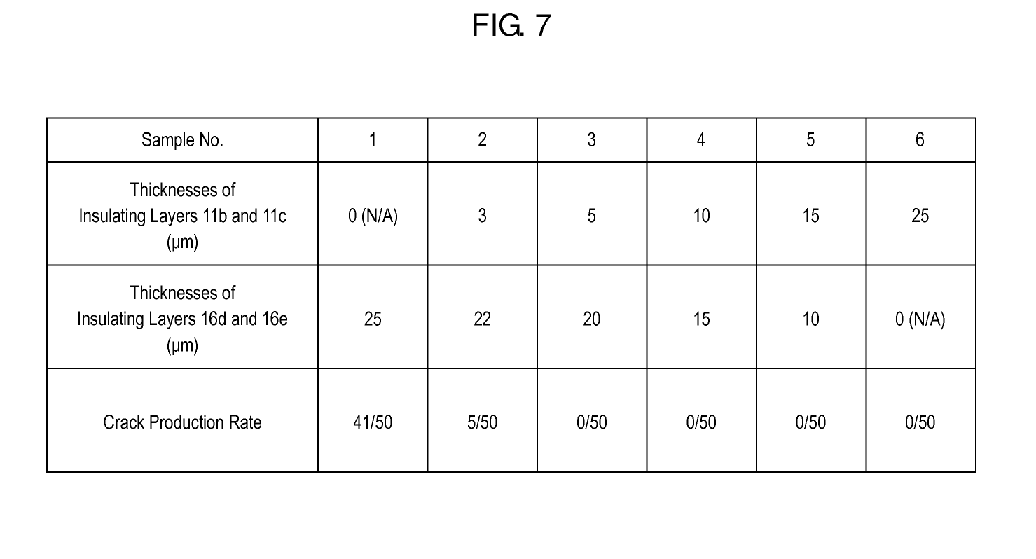

FIG. 7 shows a test result of common mode noise filter 1002 shown in FIG. 5 in accordance with Embodiment 1 in cracks. The thicknesses of insulating layers 11b, 11c, 16c, and 16d are changed to prepare sample No. 1 to 6. It was determined whether or not cracks are produced in insulating layer 11a of these samples. The total thickness of insulating layers 11b and 16c is 25 μm, and the total thickness of insulating layers 11c and 16d is also 25 μm while a thickness of insulating layer is 25 μm. Then, fifty samples of each of samples Nos. 1 to 6 are randomly chosen from about 10,000 pieces of the fired bodies having external terminal electrodes 17 formed thereon. Then, four side surfaces of each of the fifty samples are scanned with a scanning electron microscope (SEM). When a crack is observed in at least one side surface of each sample, this sample is determined as a defective. FIG. 7 shows a ratio of the number of defectives to. the number (fifty) of samples as a crack production rate.

After the firing, insulating layers 11a, 11b, 11c, 16c, and 16d are sintered and merged, hence preventing the interfaces between the layers from being observed with SEM. According to Embodiment 1, the interfaces between the layers are defined as follows: The interface between insulating layers 11a and 11b is defined as a line passing on a point bisecting coil conductor 12a in the stacking direction and extending substantially in parallel with the upper surface or the lower surface of the fired body. Similarly, the interface between insulating layers 11a and 11c is defined as a line passing on a point bisecting coil conductor 12b in the stacking direction and extending substantially in parallel with the upper surface or the lower surface of the fired body. The interface between insulating layers 11b and 16c is also defined as a line passing on a point bisecting leading electrode 13a in the stacking direction and extending substantially in parallel with the upper surface or the lower surface of the fired body. The interface between insulating layers 11c and 16d is also defined as a line passing on a point bisecting leading electrode 13b in the stacking direction and extending substantially in parallel with the upper surface or the lower surface of the sintered body. Since the sample of Sample No. 1 does not include insulating layer 11b or 11c, leading electrode 13a is disposed between insulating layer 16c and magnetic oxide layer 15a, and leading electrode 13b is disposed between insulating layer 16d and magnetic oxide layer 15b, thereby defining the interfaces between the layers. Since the sample of Sample No. 6 does not include insulating layer 16c or 16d, leading electrode 13a is disposed between insulating layer 11b and magnetic oxide layer 15a, thereby defining the interface between the layers.

The pore ratios of insulating layers 11a to 11c of the samples are 12%.

As shown in FIG. 7, Sample No. 1 exhibits a crack production rate of 41/50, larger than 80%. Sample No. 1 does not include insulating layer 11b or 11c, and the thicknesses of insulating layers 16c and 16d are 25 μm. On the other hand, Sample No. 2 exhibits a crack production rate of 5/50, 10%. Sample No. 2 includes insulating layers 11b and 11c having a thickness of 3 μm. Sample No. 2 thus has a dramatically small crack production rate. Each of Sample Nos. 3 to 6 includes insulating layers 11b and 11c having a thicknesses not smaller than 5 μm, and has a phenomenally small crack production rate of 0/50.

The crack production rates of samples which do not include insulating layer 11b or 11c and which include insulating layers 16c and 16d having a thickness of 25 μm are also measured. Leading electrodes 13a and 13b of these samples are disposed away from insulating layer 11a by 3 μm, 5 μm, 10 μm, 15 μm, and 25 μm. However, the distance between insulating layer 11a and each of leading electrodes 13a and 13b do not influence the crack production rate, so that the distance do not relate to reducing the crack production rate.

Thus, insulating layers 11b and 11c dramatically reduce the crack production rate after the firing of the conductive paste for forming external terminal electrodes 17. A thickness of each of insulating layers 11b and 11c not smaller than 5 μm can facilitate to reduce the crack production rate.

As discussed above, common mode noise filters 1001 and 1002 in accordance with Embodiment 1, insulating layer 11a provided between coil conductors 12a and 12b is made of glass-based material having plural pores 911a dispersed therein. This structure drastically reduces the stray capacitance produced between coil conductors 12a and 12b. Insulating layers 11b and 11c can prevent the structural failures, such as cracks, from occurring after the firing of external terminal electrodes 17, thus providing common mode noise filters 1001 and 1002 with excellent high-frequency characteristics at a high yield.

### Exemplary Embodiment 2

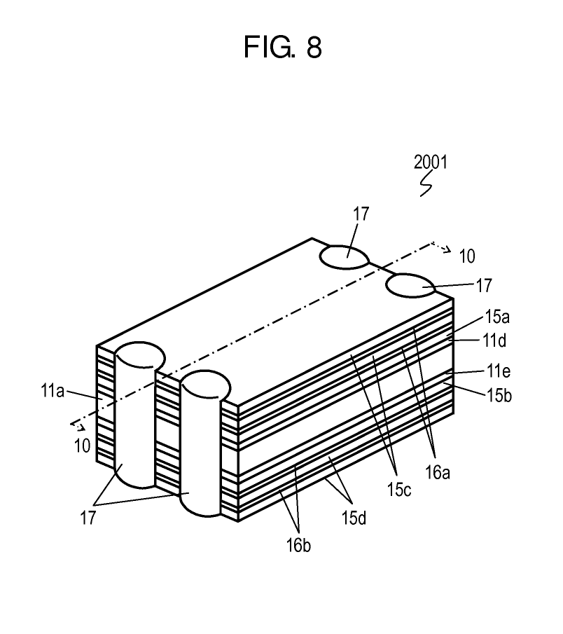

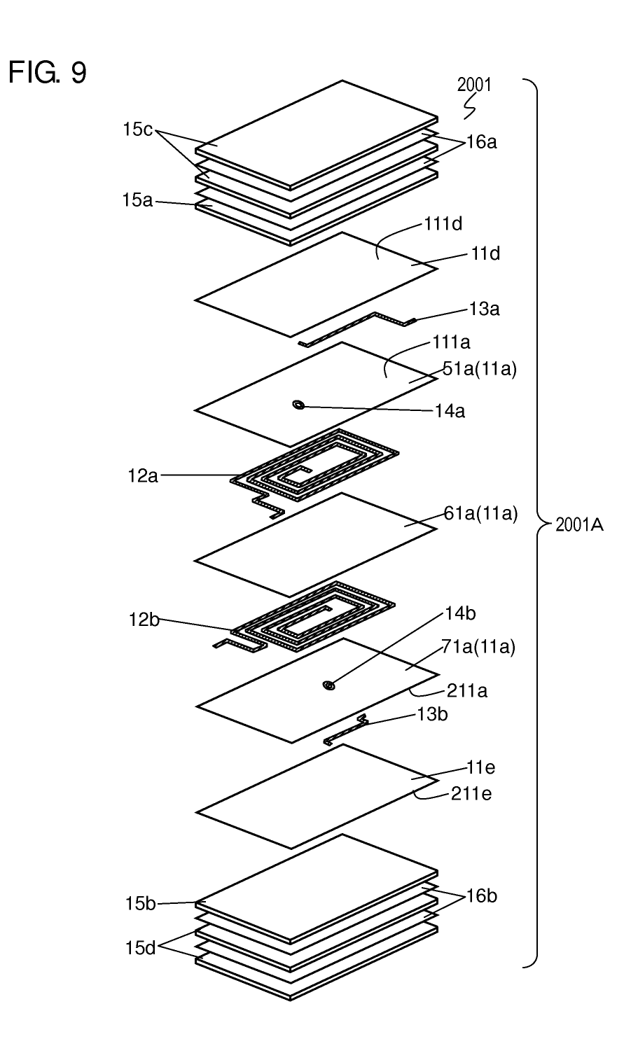

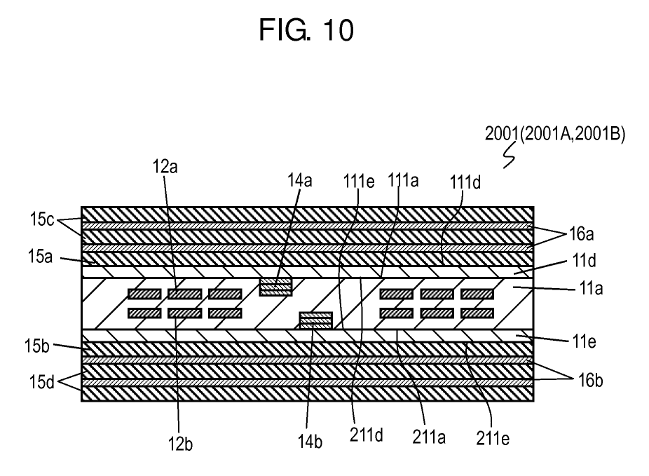

FIG. 8 and FIG. 9 are a perspective view and an exploded perspective view of common mode noise filter 2001 in accordance with Exemplary Embodiment 2 of the present invention. FIG. 10 is a cross-sectional view of common mode noise filter 2001 at line 10-10 shown in FIG. 8. In FIGS. 8 to 10, components identical to those of common mode noise filter 1001 shown in FIGS. 1 to 3 are denoted by the same reference numerals.

In common mode noise filter 2001 in accordance with Embodiment 2, coil conductors 12a and 12b are embedded in insulating layer 11a so as not to expose coil conductors 12a and 12b to upper surface 111a or lower surface 211a of insulating layer 11a. Common mode noise filter 2001 includes insulating layer 11d disposed on upper surface 111a and insulating layer 11e disposed on lower surface 211a of insulating layer 11a instead of insulating layers 11b and 11c of common mode noise filter 1001 shown in FIGS. 1 to 3.

Common mode noise filter 2001 includes insulating layer 11a, magnetic oxide layer 15a disposed above upper surface 111a of insulating layer 11a, magnetic oxide layer 15b disposed below lower surface 211a of insulating layer 11a, coil conductors 12a and 12b embedded in insulating layer 11a and facing each other, insulating layer 11d disposed between upper surface 111a of insulating layer 11a and magnetic oxide layer 15a, and insulating layer 11e disposed between lower surface 211a of insulating layer 11a and magnetic oxide layer 15b. Magnetic oxide layer 15a is disposed on upper surface 111d of insulating layer 11d. Magnetic oxide layer 15b is disposed on lower surface 211e of insulating layer 11e. Common mode noise filter 2001 further includes leading electrodes 13a and 13b electrically connected to coil conductors 12a and 12b, respectively, via-electrodes 14a and 14b connecting coil conductors 12a and 12b to leading electrodes 13a and 13b, respectively, and external terminal electrodes 17 connected to coil conductors 12a and 12b and leading electrodes 13a and 13b. Insulating layer 11a contains borosilicate glass and inorganic filler. Insulating layers 11a, 11d, and 11e are different from magnetic oxide layers 15a and 15b in that insulating layers 11a, 11d, and 11e are non-magnetic layers containing substantially no magnetic properties. Insulating sheet layers 51a, 61a, and 71a are stacked on each other to provide insulating layer 11a.

Common mode noise filter 2001 further includes one or more magnetic oxide layers 15c made of the same material as magnetic oxide layer 15a, one or more magnetic oxide layers 15d made of the same material as magnetic oxide layer 15b, one or more insulating layers 16a, and one or more insulating layers 16b. Insulating layers 16a are stacked alternately on magnetic oxide layers 15a and 15c. Insulating layers 16b are stacked alternately on magnetic oxide layers 15b and 15d. Leading electrode 13a is disposed on upper surface 111a of insulating layer 11a. Via-electrode 14a penetrates insulating sheet layer 51a of insulating layer 11a. Insulating layer 11d is disposed on upper surface 111a of insulating layer 11a to contact and cover leading electrode 13a. Leading electrode 13b is disposed on lower surface 211a of insulating layer 11a. Via-electrode 14b penetrates insulating sheet layer 71a of insulating layer 11a. Insulating layer 11e is disposed on lower surface 211a of insulating layer 11a to contact and cover leading electrode 13b.

Coil conductors 12a and 12b can be formed by plating a conductive material, such as Ag, into a spiral shape, and are embedded in insulating layer 11a. Leading electrode 13a is disposed between insulating layers 11a and 11d, and leading electrode 13b is disposed between insulating layers 11a and 11e. Coil conductors 12a and 12b are electrically connected to leading electrodes 13a and 13b through via-electrodes 14a and 14b, respectively.

Insulating layers 11a, 11d, and 11e are made of glass-based non-magnetic material containing borosilicate glass and inorganic filler, and has insulating properties.

Magnetic oxide layers 15a and 15b are made of magnetic material, such as ferrite, mainly made of Fe₂O₃.

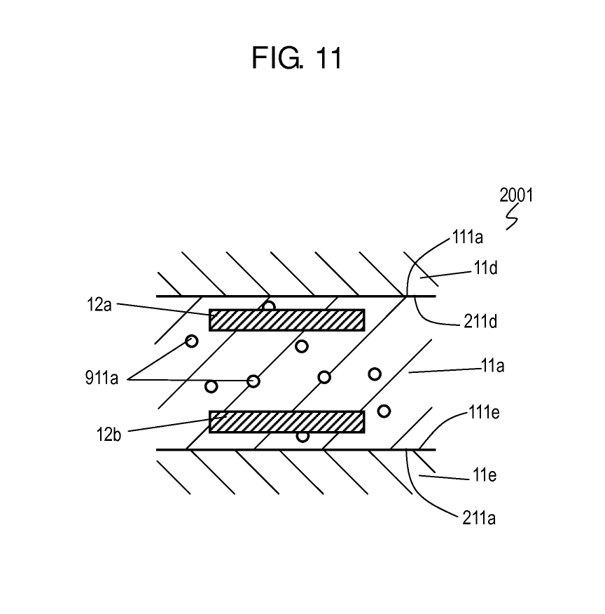

FIG. 11 is an enlarged cross-sectional view of common mode noise filter 2001. Plural pores 911a are dispersed in insulating layer 11a.

Insulating layers 11d and 11e have substantially no pores therein. This means that the glass-based material which does not contains additive for forming pores is sintered sufficiently, and the glass-based material preferably has a pore ratio not larger than 2%.

The glass composition of borosilicate glass contained in insulating layers 11a, 11d, and 11e preferably contains at least one material selected from Al₂O₃ and oxide of alkali metal in addition to SiO₂ and B₂O₃. The glass composition preferably contains substantially no PbO in order to avoid adverse affection on the environment.

The borosilicate glass contained in insulating layers 11a, 11d, and 11e preferably has a yield point not lower than 550° C. and not higher than 750° C. The yield point lower than 550° C. allows the glass to deform greatly during the firing, and may allow the plating to cause a problem since chemical resistance of the glass is weakened. The yield point exceeding 750° C. may cause the insulating layers to have insufficient densification in the temperature range allowing coil conductors 12a and 12b to be fired simultaneously to the insulating layers.

The inorganic filler contained in insulating layers 11a, 11d, and 11e can be material, such as aluminum oxide, diopside, mulite, cordierite, or silica, as long as the material has resistance to reacting with the borosilicate glass during the firing. Cordierite or silica particularly out of the above materials having a low dielectric constant may be preferably used as the inorganic filler to effectively reduce the dielectric constant of insulating layer 11a.

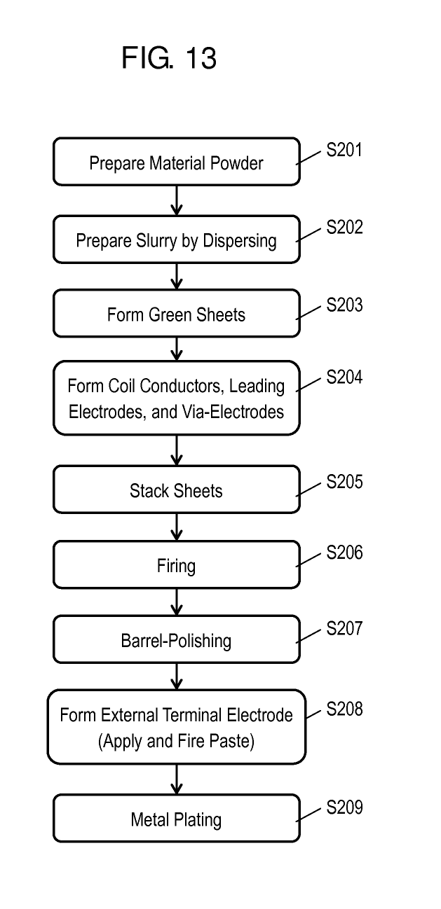

A method for manufacturing common mode noise filter 2001 in accordance with Embodiment 2 will be described below. FIG. 13 is a flowchart illustrating processes for manufacturing common mode noise filter 2001.

First, insulating sheets constituting insulating-sheet layers 51a, 61a, and 71a of insulating layer 11a are prepared and provided. 63 wt % of borosilicate glass powder, 4 wt % of SrCO₃ powder, and 33 wt % of inorganic filler are mixed to produce mixed powder (Step S201). Then, butyral resin (PVB), acrylic resin, and butyl benzyl phthalate (BBP) plasticizer are mixed together to produce organic binder. Then, the mixed powder is dispersed in the organic binder, thereby producing a slurry (Step S202).

Next, this slurry is applied onto a polyethylene terephthalate (PET) film by a doctor blade method to shape the slurry, thereby obtaining an insulating sheet, i.e., a green sheet (Step S203).

Insulating sheets constituting insulating layers 11d and 11e are provided. 66 wt % of borosilicate glass powder, 34 wt % of inorganic filler are mixed together to produce mixed powder. Then, a slurry is produced from this mixed powder by the same production method of making the insulating sheet for insulating-sheet layers 51a, 61a, and 71a. Then, this slurry is shaped into the insulating sheets.

Magnetic oxide sheets constituting magnetic oxide layers 15a to 15d are prepared and provided. 100 wt % of ferrite material powder is prepared. Then, a slurry is made from the ferrite material powder by the same production method of the insulating sheet forming insulating-sheet layers 51a, 61a, and 71a. This slurry is shaped into the magnetic oxide sheets.

Insulating sheets constituting insulating layers 16a and 16b are prepared and provided: 69 wt % of borosilicate glass powder and 31 wt % of inorganic filler are mixed together to produce mixed powder. Then, a slurry is made from the mixed powder by the same production method of the insulating sheets for insulating-sheet layers 51a, 61a, and 71a. This slurry is shaped into the insulating sheets.

According to Embodiment 2, insulating layer 11a, i.e., insulating sheet layers 51a, 61a, and 71a, insulating layers 11d and 11e are made of the same glass and the same inorganic filler. The glass-based material increases the adhesive strength between insulating layers 11d and 11e and magnetic oxide layers 15a and 15b. The glass-based material forms a binding layer in the glasses between insulating layer 11a and each of insulating layers 11d, 11e, so that the binding layer may increase the adhesive strength between these layers.

Next, form via holes at predetermined places on the insulating sheet forming insulating layers 51a and 71a, and then fill the via holes with conductive paste made of Ag powder and glass frit. This conductive paste is fired to form via-electrodes 14a and 14b (Step S204).

Then, coil conductors 12a and 12b and leading electrodes 13a and 13b are formed. Conductive patterns constituting coil conductors 12a and 12b and leading electrodes 13a and 13b are formed by plating a base board with Ag, and then, are transferred from the base board onto the insulating sheets constituting insulating-sheet layers 51a, 61a, and 71a or insulating layers 11d and 11e.

The method for producing these sheets is not limited to the foregoing method. For instance, each layer can be formed by a paste printing method. The methods for producing coil conductors 12a and 12b, leading electrodes 13a and 13b, and via-electrodes 14a and 14b are not limited to the foregoing ones.

Then, the sheets including the insulating sheet having the conductive patterns transferred thereon are stacked to form a laminated sheet body. The laminated sheet body is then cut into pieces having predetermined sizes, thereby providing individual laminated bodies 2001A (Step S205). A chip component, such as common mode noise filter 1001, is often produced by cutting the layered sheet body having a size larger than a 50 mm square into a chip having a size of about 1-2 mm square, thereby obtaining laminated body 2001A.

Next, laminated body 2001A is fired at a predetermined temperature for a predetermined period of time to sintering the laminated body and to generate gas from the inorganic foaming agent, thereby obtaining fired body 2001B (Step S206). At this moment, the inorganic foaming agent, the SrCO₃ powder, mixed in the materials of insulating-sheet layer 51a, 61a, and 71a of insulating layers 11a is thermally decomposed, and produces carbon dioxide gas in laminated body 2001A. The gas produces plural pores 911a in each of insulating sheet layers 51a, 61a, and 71a, namely, insulating layer 11a while Sr element is left in insulating layer 11a. In the case that CaCO₃ is used as the inorganic foaming agent, plural pores 911a are produced in insulating layer 11a while Ca element is left in insulating layer 11a.

Then, the fired bodies are subject to barrel polishing (Step S207). To be more specific, about 10,000 pieces of the fired bodies, media having a diameter of 2 mm, SiC polishing agent, and pure water are put into a planetary mill, and spun at 150 rpm for 10 minutes, thereby smoothing undulations on surfaces of the fired bodies as well as rounding shape portions thereon, thereby allowing external terminal electrodes 17 to be thus applied securely onto the fired bodies.

After the barrel polishing, conductive pastes made of Ag powder and glass frit are applied onto both sides of each fired body such that the conductive pastes are electrically connected to coil conductors 12a and 12b and leading electrodes 13a and 13b. Then, the conductive pastes are subject to heat treatment at 700° C., thereby forming external terminal electrodes 17 (Step S208).

Insulating layers 11a of common mode noise filter 2001 in accordance with Embodiment 2 contain only independent closed pores therein and contains few open communicating pores, thus providing sufficient insulating reliability without a post treatment, such as resin impregnation. In order to obtain higher reliability, after external terminal electrodes 17 are formed, the fired body can be immersed into fluoro-silane coupling agent so that the open pores on the surface can be impregnated with resin.

Finally, a nickel-plated layer and a tin-plated layer are formed on the surface of each one of external terminal electrodes 17 by plating, providing common mode noise filter 2001 (Step S209).

Common mode noise filter 2001 in accordance with Embodiment 2 has a strong bonding between magnetic oxide layers 15a, 15b containing magnetic substance, such as ferrite, and insulating layer 11a containing pores 911a therein. This structure prevents delamination at the interfaces between magnetic oxide layers 15a and 15b and insulating layers 11d and 11e due to stress generated in the post steps, such as the barrel polishing, after the firing.

Common mode noise filter 2001 in accordance with Embodiment is phenomenally excellent in high-frequency characteristics due to insulating layer 11a made of glass-based material having pores 911a dispersed therein, similarly to common mode noise filter 1001 in accordance with Embodiment 1.

Insulating layer 11a of common mode noise filter 2001 in accordance with Embodiment 2 contains glass and inorganic filler as well as plural pores 911a dispersed therein. Coil conductors 12a and 12b facing each other are embedded in insulating layer 11a so as not to expose coil conductors 12a and 12b to upper surface 111a or lower surface 211a of insulating layer 11a. Magnetic oxide layer 15a is disposed above upper surface 111a of insulating layer 11a. Magnetic oxide layer 15b is disposed below lower surface 211a of insulating layer 11a. Insulating layer 11d containing glass and inorganic filler is disposed between magnetic oxide layer 15a and upper surface 111a of insulating layer 11a. Insulating layer 11e containing glass and inorganic filler is disposed between magnetic oxide layer 15b and lower surface 211a of insulating layer 11a. A total volume of the pores in insulating layer 11d per unit volume is smaller than a total volume of pores 911a of insulating layer 11a per unit volume. A total volume of the pores in insulating layer 11e per unit volume is smaller than the total volume of pores 911a of insulating layer 11a per unit volume. Insulating layers 11d and 11e may contain substantially no pore therein.

Common mode noise filter 2001 in accordance with Embodiment 2 can obtain strong bonding on the interfaces between insulating layers 11d and 11e and magnetic oxide layers 15a and 15b for the following reasons.

In the case that non-magnetic ferrite material, such as Cu—Zn based material is used for insulating layer 11a, upon directly contacting magnetic oxide layers 15a and 15b, insulating layer 11a produces a reaction layer between insulating layer 11a and the ferrite material in magnetic oxide layers 15a and 15b due to inter-diffusion during the firing, so that the reaction layer provides the strong bonding. In the case that glass-based material is used for insulating layer 11a in accordance with Embodiment 2, insulating layer 11a does not produce the reaction layer, and only fusion force of the glass is obliged to maintain a secure contact between these layers. In the case that the glass-based material containing plural pores 911a therein is used for insulating layer 11a, pores 911a exist on the interfaces between insulating layer 11a and each of magnetic oxide layers 15a and 15b, and reduce an actual fused area of the glass, hence hardly maintain the secure contact.

In common mode noise filter 2001 in accordance with Embodiment 2, insulating layer 11d is disposed between magnetic oxide layer 15a and insulating layer 11a, and insulating layer 11e is disposed between magnetic oxide layer 15b and insulating layer 11a. Each of a total volume of pores per unit volume contained in insulating layer 11d and that of layer 11e is smaller than that of insulating layer 11a. This structure increases the fused area between magnetic oxide layer 15a and insulating layer 11d, and also increases the fused area between magnetic oxide layer 15b and insulating layer 11e, accordingly allowing magnetic oxide layer 15a to be strongly bonded to insulating layer 11d and allowing magnetic oxide layer 15b to be strongly bonded to insulating layer 11e. Insulating layers 11d and 11e to be bonded to magnetic oxide layers 15a and 15b are made of glass-based material similarly to insulating layer 11a. A fused area of the interface (i.e. upper surface 111a of insulating layer 11a) between insulating layers 11d and 11a becomes smaller, and a fused area of the interface (i.e. lower surface 211a of insulating layer 11a) between insulating layers 11e and 11a becomes also smaller. However, microscopic individual fused parts have no interfaces and they are unified, so that insulating layers 11a, 11d, and 11e are bonded to each other strongly.

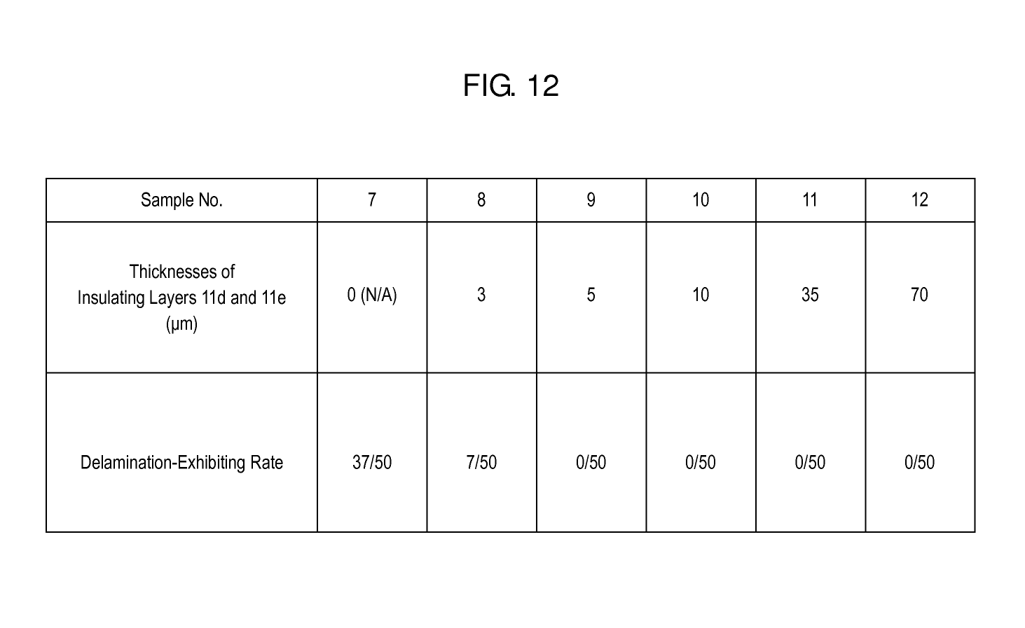

FIG. 12 shows a test result of common mode noise filter 2001 in accordance with Embodiment in delamination. Samples of Sample Nos. 7 to 12 have different thicknesses of insulating layers 11d and 11e. The delamination is checked on the interface between insulating layer 11d and magnetic oxide layer 15a and on the interface between insulating layer 11e and magnetic oxide layer 15b. In these samples, a distance between coil conductors 12a and 12b, namely, a thickness of insulating-sheet layer 61a of insulating layer 11a, is 25 μm. A distance between coil conductor 12a and insulating layer 11d, namely, a thickness of insulating-sheet layer 51a of insulating layer 11a, is 25 μm. A distance between coil conductor 12b and insulating layer 11e, namely, a thickness of insulating-sheet layer 71a of insulating layer 11a, is 25 μm. Fifty samples are randomly chosen for each of sample Nos. 7 to 12 from about 10,000 pieces after the firing and the barrel polishing. Four side surfaces of each of the fifty samples are observed with a scanning electron microscope (SEM). A sample exhibiting a delamination on at least one side surface is regarded as a defective.

Insulating layers 11a, 11d, and 11e are sintered and unified. In the case that these layers are made of the same material, even the observation with SEM may not distinctively find the interfaces between these layers. However, In the above manufacturing method, leading electrode 13a is disposed between insulating layers 11a and 11d, and leading electrode 13b is disposed between insulating layers 11a and 11e, so that the interfaces between these layers can be clearly defined as leading electrodes 13a and 13b.

Next, a method for measuring a volume of pores in insulating layers 11a, 11d, and 11e per unit volume will be described below.

First, a place at which the volume of pores is measured in each layer per unit volume will be described. The volume of pores 911a in insulating layer 11a per unit volume is obtained by measuring the volume of pores 911a between coil conductors 12a and 12b. The volume of the pores in insulating layer 11d is obtained by measuring the volume thereof between magnetic oxide layer 15a and coil conductor 12a. The volume of the pores in insulating layer 11e is obtained by measuring thereof between magnetic oxide layer 15d and coil conductor 12b. Photographs of five sections of the fired body captured with SEM are image-processed to calculate area SP of the pores in each layer and whole cross sectional area SB of the fired body. The volume of the pores per unit volume, namely, a pore ratio TV, is obtained by the following formula:

TV=SP^{3/2}/SB^{3/2}

The pore ratio of insulating layers 11a of the samples shown in FIG. 12 is 12%. As shown in FIG. 12, sample No. 7 does not include insulating layers 11d or 11e, and insulating layer 11a directly contact magnetic oxide layers 15a and 15b. The delamination is exhibited in Sample No. 7 at a rate of 37/50, namely, greater than 70%. Sample No. 8 includes insulating layers 11d and 11e. The delamination is exhibited in Sample No. 8 at a rate of 7/50, namely, about 15%. Each of Sample Nos. 9 to 12 includes thicker insulating layers 11d and 11e than the other samples. The delamination is exhibited in Sample Co. 9 to 12 at a rate of 0/50, providing excellent result.

As discussed above, insulating layers 11d and 11e provided between insulating layer 11a and each of magnetic oxide layers 15a and 15b reduces the ratio of delamination after the barrel polishing.

In common mode noise filter 2001 in accordance with Embodiment 2, coil conductors 12a, 12b are disposed inside insulating layer 11a made of glass-based material and having plural pores 911a dispersed therein. This structure reduces a stray capacitance produced between coil conductors 12a and 12b, and provides common mode noise filter 2001 with phenomenally excellent high-frequency characteristics. Insulating layer 11d having substantially no pore dispersed therein is disposed between insulating layer 11a and magnetic oxide layer 15a. Insulating layer 11e having substantially no pore dispersed therein is disposed between insulating layer 11a and magnetic oxide layer 15b. This structure can reduce the delamination between magnetic oxide layer 15a and insulating layer 11d and the delamination between magnetic layer 15b and insulating layer 11e, providing a high yield rate.

Insulating layers 11d and 11e of common mode noise filter 2001 in accordance with Embodiment 2 may contain pores dispersed therein. A total volume of the pores in each of insulating layers 11d and 11e per unit volume is preferably smaller than a total volume of pores 911a in insulating layer 11a per unit volume. This structure prevents the delamination between each of magnetic oxide layers 15a and 15b and each of insulating layers 11d and 11e. In this case, when the insulating sheets constituting insulating layers 11d and 11e are prepared, the inorganic foaming agent is added to the mixed powder that is the material for the insulating sheets, similarly to the filter according to Embodiment 1.

Each of common mode noise filters 1001, 1002 and 2001 in accordance with Embodiments 1 and 2 includes two coil conductors 12a and 12b, but the number of the coils is not necessarily two. For instance, each of common mode noise filters 1001, 1002 and 2001 in accordance with Embodiments 1 and 2 may be an array-type filter including plural pairs of coil conductors 12a and 12b facing each other.

In Embodiments 1 and 2, terms, such as “upper surface”, “lower surface”, “above”, and “below” indicating directions merely indicate relative directions depending only on relative positional relations of structural components, such as the insulating layers and the magnetic oxide layers, of the common mode noise filters, and do not indicate absolute directions, such as a vertical direction.

### INDUSTRIAL APPLICABILITY

A common mode noise filter according to the present invention can prevent cracks from produced therein, can work at a high-frequency band, and can be manufactured at a high yield rate, thus being useful for reducing noises in various electronic apparatuses, such as digital devices, audio-visual devices, and information communication terminals.

### REFERENCE MARKS IN THE DRAWINGS

11a Insulating Layer (First Insulating Layer)
11b Insulating Layer (Second Insulating Layer)
11c Insulating Layer (Third Insulating Layer)
11d Insulating Layer (Second Insulating Layer)
11e Insulating Layer (Third Insulating Layer)
12a Coil Conductor (First Coil Conductor)
12b Coil Conductor (Second Coil Conductor)
15a Magnetic Oxide Layer (First Magnetic Oxide Layer
15b Magnetic Oxide Layer (Second Magnetic Oxide Layer
16c Insulating Layer (Fourth Insulating Layer)
16d Insulating Layer (Fifth Insulating Layer)
17 External Terminal Electrode
51a Insulating Layer (Second Insulating Layer)
61a Insulating Layer (First Insulating Layer)
71a Insulating Layer (Third Insulating Layer)
911a Pore (First Pore)
911b Pore (Second Pore)
911c Pore (Third Pore)
1001 Common Mode Noise Filter
1002 Common Mode Noise Filter
2001 Common Mode Noise Filter

1. A common mode noise filter comprising:
a first insulating layer containing glass and inorganic filler, the first insulating layer containing a plurality of pores dispersed therein;
a first coil conductor disposed on an upper surface of the first insulating layer;
a second coil conductor disposed on a lower surface of the first insulating layer, the second coil conductor facing the first coil conductor across the first insulating layer;
a second insulating layer disposed on the upper surface of the first insulating layer to cover the first coil conductor, the second insulating layer containing glass and inorganic filler, the second insulating layer containing a plurality of pores dispersed therein;
a third insulating layer disposed on the lower surface of the second insulating layer to cover the second coil conductor, the third insulating layer containing glass and inorganic filler, third insulating layer containing a plurality of pores dispersed therein;
a first magnetic oxide layer disposed above an upper surface of the second insulating layer; and
a second magnetic oxide layer disposed below a lower surface of the third insulating layer such that the first insulating layer, the second insulating layer, and the third insulating layer are provided between the first magnetic oxide layer and the second magnetic oxide layer.

2. The common mode noise filter according to claim 1, wherein the first magnetic oxide layer is disposed on the upper surface of the second insulating layer.

3. The common mode noise filter according to claim 2, wherein the second magnetic oxide layer is disposed on the lower surface of the third insulating layer.

4. The common mode noise filter according to claim 1, further comprising:
a first leading electrode disposed on the upper surface of the second insulating layer and connected electrically to at least one of the first coil conductor and the second coil conductor; and
a fourth insulating layer disposed on the upper surface of the second insulating layer to cover the first leading electrode, the fourth insulating layer containing glass component,
wherein the first magnetic oxide layer is disposed on an upper surface of the fourth insulating layer.

5. The common mode noise filter according to claim 4, further comprising:
a second leading electrode disposed on the lower surface of the third insulating layer and connected electrically to at least one of the first coil conductor and the second coil conductor; and
a fifth insulating layer disposed on the lower surface of the third insulating layer to cover the second electrode, the fifth insulating layer containing glass component,
wherein the second magnetic oxide layer is disposed on a lower surface of the fifth insulating layer.

6. A common mode noise filter comprising:
a first insulating layer containing glass and inorganic filler, the first insulating layer containing a plurality of first pores dispersed therein;
a first coil conductor provided in the first insulating layer so as not to be exposed to an upper surface and a lower surface of the first insulating layer;
a second coil conductor provided in the first insulating layer so as not to be expose to the upper surface and the lower surface of the first insulating layer, the second coil conductor facing the first coil conductor across a part of the first insulating layer;
a second insulating layer disposed on the upper surface of the first insulating layer, the second insulating layer containing glass and inorganic filler;
a third insulating layer disposed on the lower surface of the first insulating layer such that the first insulating layer is provided between the second insulating layer and the third insulating layer, the third insulating layer containing glass and inorganic filler;
a first magnetic oxide layer disposed above an upper surface of the second insulating layer; and
a second magnetic oxide layer disposed below a lower surface of the third insulating layer,
wherein a total volume of pores contained in the second insulating layer per unit volume and a total volume of pores contained in the third insulating layer per unit volume are smaller than a total volume of the first pores in the first insulating layer per unit volume.

7. The common mode noise filter according to claim 6,
wherein the second insulating layer contains substantially no pore dispersed therein, and
wherein the third insulating layers contains substantially no pore dispersed therein.

8. The common mode noise filter according to claim 1 or 6, wherein thicknesses of the second insulating layer and the third insulating layer are not smaller than 5 μm.

9. The common mode noise filter according to claim 1 or 6, wherein the first insulating layer, the second insulating layer, and the third insulating layer comprise alkaline earth metal element.

10. The common mode noise filter according to claim 1 or 6,
wherein the glass contained in the first insulating layer and the glass contained in the second insulating layer are made of a same material,
wherein the glass contained in the first insulating layer and the glass contained in the third insulating layer are made of a same material,
wherein the inorganic filer contained in the first insulating layer and the inorganic filer contained in the second insulating layer are made of a same material, and
wherein the inorganic filler contained in the first insulating layer and the inorganic filer contained in the third insulating layer are made of a same material.

11. The common mode noise filter according to claim 1 or 6, wherein the first insulating layer, the second insulating layer, and the third insulating layer contain borosilicate glass and silica filler.

12. A method of manufacturing a common mode noise filter, comprising:
providing a first insulating sheet containing glass, inorganic filler, inorganic foaming agent, and organic binder;
providing a second insulating sheet containing glass, inorganic filler, inorganic foaming agent, and organic binder;
providing a third insulating sheet containing glass, inorganic filler, inorganic forming agent, and organic binder;
providing a first magnetic oxide sheet mainly made of magnetic material and containing organic binder;
preparing a second magnetic oxide sheet mainly made of magnetic material and containing organic binder;
forming a laminated body which includes
a first coil conductor disposed on an upper surface of the first insulating sheet,
the second insulating sheet disposed on the upper surface of the first insulating sheet for covering the first coil conductor,
a second coil conductor disposed on a lower surface of the first insulating sheet,
the third insulating layer disposed on the lower surface of the first insulating sheet for covering the second coil conductor,
the first magnetic oxide sheet disposed above an upper surface of the second insulating sheet, and
the second magnetic oxide sheet disposed below a lower surface of the third insulating sheet, such that the first insulating sheet, the second insulating sheet, and the third insulating sheet are provided between the first magnetic oxide sheet and the second magnetic oxide sheet,
obtaining a fired body by firing the laminated body for producing gas from the inorganic foaming agent contained in the first insulating sheet, the inorganic foaming agent contained in the second insulating sheet, and the inorganic foaming agent contained in the third insulating sheet as to form a plurality of pores in each of the first insulating sheet, the second insulating sheet, and the third insulating sheet; and
providing an external terminal electrode on the fired body.

13. A method of manufacturing a common mode noise filter, comprising:
providing a first insulating sheet layer, a second insulating sheet layer, and a third insulating sheet layer that contain glass, inorganic filler, inorganic foaming agent, and organic binder and that are configured to be laminated to provide a first insulating sheet;
providing a second insulating sheet containing glass, inorganic filler, and organic binder;
providing a third insulating sheet containing glass, inorganic filler, and organic binder;
providing a first magnetic oxide sheet mainly made of magnetic material and containing organic binder;
providing a second magnetic oxide sheet mainly made of magnetic material and containing organic binder;
forming a laminated body which includes
a first coil conductor disposed on an upper surface of the first insulating-sheet layer.
the second insulating sheet layer disposed on the upper surface of the first insulating sheet layer to cover the first coil conductor.
a second coil conductor disposed on a lower surface of the first insulating sheet layer,
the third insulating sheet layer disposed on the lower surface of the first insulating sheet layer to cover the second coil conductor,
the second insulating layer disposed on an upper surface of the second insulating-sheet layer,
the third insulating sheet disposed on a lower surface of the third insulating sheet layer, such that the first insulating sheet layer, the second insulating sheet layer, and the third insulating sheet layer are sandwiched between the second insulating sheet and the third insulating sheet;
the first magnetic oxide sheet disposed above an upper surface of the second insulating sheet, and
the second magnetic oxide sheet disposed below a lower surface of the third insulating sheet, such that the first insulating sheet layer, the second insulating sheet layer, and the third insulating sheet layer, the second insulating sheet, and the third insulating sheet are sandwiched between the first magnetic oxide sheet and the second magnetic oxide sheet; and
obtaining a fired body by firing the laminated body to generate gas from the inorganic foaming agent contained in the first insulating sheet layer, the second insulating sheet layer, and the third insulating sheet layer, as to form a plurality of pores in each of the first insulating sheet layer, the second insulating sheet layer, and the third insulating sheet layer; and
providing an external terminal electrode on the fired body.

14. The method according to claim 12 or 13, wherein the inorganic foaming agent contains alkaline earth carbonate.
